(19) United States
(12) Patent Application Publication
(10) Pub. No.: US 2003/0010731 A1
(43) Pub. Date: Jan. 16, 2003

(54) Stacker of a printing press

(76) Inventors: Gerhard Bartscher, Koln (DE); Udo Drager, Speyer (DE)

Correspondence Address: Lawrence P. Kessler, Patent Department, NexPress Solutions LLC, 1447 St. Paul Street, Rochester, NY, 14653-7103, US

(21) Appl. No.: 10/179,105

(22) Filed: Jun. 25, 2002

(30) Foreign Application Priority Data
Jul. 11, 2001 (DE) 101 33 725.6

(51) Int. Cl. B41F 1/54

(52) U.S. Cl. 211/50; 101/484

(57) ABSTRACT

A stacker for evenly stacking sheets of paper in a simple way. To this end, inserts between the sheets of paper of a paper stack are provided for leveling the paper stack. Furthermore, gripping supporting components on the sides of the paper stack for uniform alignment of the side faces of the paper stack and at least one vibrating device for exact alignment of the sheets of paper.

### FIELD OF THE INVENTION

The invention is related to stacking of sheets for a printing press wherein inserts are used to level the stack or sheets accumulated in the stack.

### BACKGROUND OF THE INVENTION

With printing presses, sheets of paper from a sheet supply, are transported to the printing press, to have prints made thereon, and then are conveyed to a stacker in which the printed sheets of paper are stacked. The paper sheets are then either removed or, in other cases, further processed and fed into a finisher at the exit of the stacker. The sheet stacking process often leads to an uneven stacking of the individual sheets of paper, i.e., the sheets of paper do not lie with their entire faces at one height such that they are not level. The unevenly stacked sheets of paper will thus result in considerably skewed pile of the paper stack. The disadvantages of this is that increased floor space is required compared to a level stacking of the paper stack and that the automatic further processing by finishers is impeded.

### SUMMARY OF THE INVENTION

Accordingly, it is the purpose of this invention to provide a stacker that makes it possible to evenly stack sheets of paper in a simple way. To this end, inserts are provided between the sheets of paper of a paper stack of the stacker for leveling the paper stack. Furthermore, the invention discloses gripping supporting components on the lateral faces of the paper stack for the uniformly even alignment of the lateral faces of the paper stack and at least one vibration device for the exact alignment of the paper stack. The paper stack is also perfectly aligned in the longitudinal and traverse direction with this arrangement. A particular embodiment provides a measuring device for measuring a level stack height of sheets of paper in a paper stack and a triggering device for triggering the insertion of an insert based on the measurements of the measuring device. In this way, inserts are then only inserted if there is an uneven stack height.

The inserts may be made of sheet metal and may have approximately the same dimensions as the stacked sheets of paper. In this way, a carrier for the following sheets of paper is provided, which has a even height on its entire face and which makes it possible to stack the sheets of paper at the same height, i.e., level with the paper stack. The inserts may have some of the dimensions of the stacked sheets of paper and may be inserted into a section of the paper stack that has a lower height than the other sections, in order to even out the height difference between the sections, so that the paper stack is level. The inserts may be such that they can be lifted and lowered; i.e., the height at which the inserts are inserted into the paper stack can be adjusted in various applications, e.g., to various paper sheet thicknesses or toner layer thicknesses on the sheets of paper.

The invention, and its objects and advantages, will become more apparent in the detailed description of the preferred embodiment presented below.

### BRIEF DESCRIPTION OF THE DRAWINGS

In the detailed description of the preferred embodiment of the invention presented below, reference is made to the accompanying drawings, in which:

FIG. 1 is a front view of an outline of an uneven paper stack without inserts;

FIG. 2 is a front view of an outline of an even paper stack leveled by inserts according to this invention;

FIG. 3 is a front view of an outline of one of the even paper stacks leveled by inserts according to this invention, with a measuring device, whereby the inserts have some of the dimensions of the deposited sheet; and

FIG. 4. is a top view of an outline of a paper stack with four metal bars that grip the lateral faces of the paper stack according to an additional aspect of this invention.

### DETAILED DESCRIPTION OF THE INVENTION

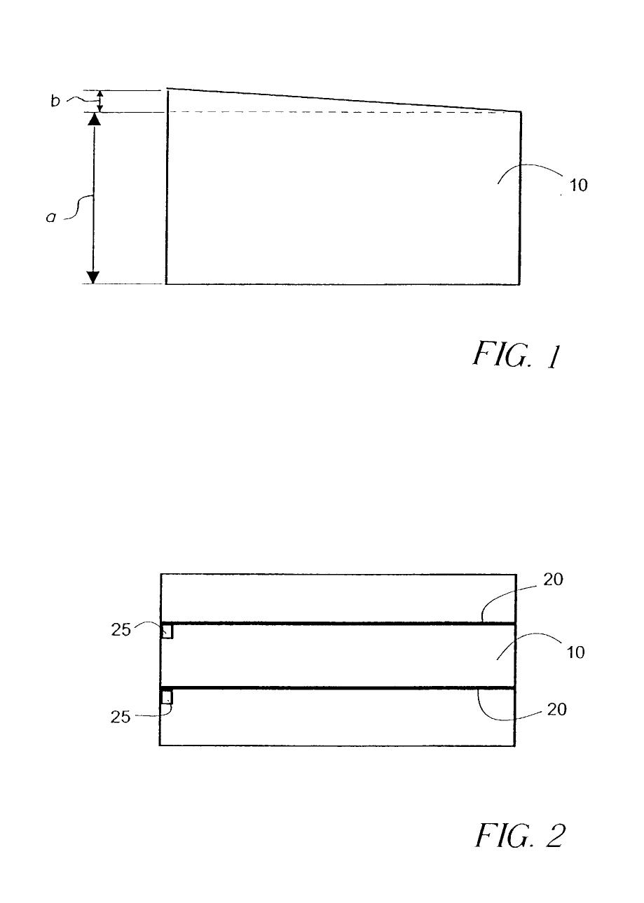

FIG. 1 illustrates a front view of an outline of a paper stack 10, within a stacker of a printing press, the left side of the paper stack being higher than its right side. An even paper stack is illustrated with the dotted line and with the stack height a. The uneven stacking of the sheets of paper on the paper stack 10 incurs an incorrect height on the left side of the paper stack 10, which is indicated by b, and identifies a stacking error. Such errors in stacks occur, for example, because parts of the sheets of paper are printed unevenly or with a thicker toner layer than other parts. In FIG. 1, for example, the left side of the paper stack 10 may have been printed with a thicker toner layer than the right side.

An exemplary calculation should make this fact of uneven stacking clear. The individual sheets of paper in the stacks have a thickness of 100 μm, the thickness of the toner layer applied to each of the paper sheets is 10 μm, and 5,000 sheets of such toned paper are stacked in the paper stack 10. However, the toner layer has only been applied to the left side of the sheets of paper. It thus follows that the left side of the paper stack according to FIG. 1 has a stack height of 0.55 m, whereas the right side has a lower stack height of 0.5 m. Thus, the stacking error (b), the difference of the stack height with the toner layer on the left side and without on the right side according to FIG. 1, is 5 cm in this case. This significant stacking error impedes or prevents the automatic further processing by the finishers, which are spatially located after the stacker of the printing press. Accordingly, such stacking error must be suppressed to enable desired smooth operation of further processing.

FIG. 2 schematically illustrates a front view of an evenly stacked paper stack 10 (without a stacking error); i.e., the entire face of the sheets of paper, and particularly the uppermost sheets of paper are exactly at the same height. In this embodiment, the paper stack 10 has been automatically provided with two inserts 20. The inserts 20 are rectangular sheet metal plates whose faces approximately match the faces of the sheets of paper, and which are aligned exactly horizontally. The exactly horizontal alignment is achieved by a firm clamping of the inserts 20 to the stacker. Once an insert 20 has been inserted, the following sheets of paper are evenly stacked. The stack height at which the inserts 20 are inserted into the paper stack 10 is determined by the expected stacking error and the requirements for the evenness of the paper stack 10.

In the case according to FIG. 2, two inserts 20 over the entire stack height of the paper stack 10 are sufficient . With respect to the triggering time for inserting the inserts 20, two possible solutions are disclosed. The first solution is a clock pulse of a triggering device, which is initiated following the startup of the printing press and the stacking of sheets of paper on the stacker, which counts up and triggers the insertion of an insert 20 at a given time. This time is calibrated with a clock pulse frequency during which a given number of sheets of paper are stacked on top of the paper stack 10. The pulse count is stopped during the printing pauses of the printing press. The triggering device may be a part of the control device of the printing press. The second solution discloses sensors 25 that are firmly applied to the stacker close to the paper stack 10 and which detect when the paper stack 10 reaches a given stack height. The given stack height is adapted to the respective application and particularly to the expected error height b. In reaction to reaching the given stack height and the detection by the sensors 25, as well as to a corresponding sensor signal, an insert 20 is inserted into the paper stack 10 on the sheet that has been on top up to this point. The insertion of the insert 20 is carried out “on the fly”, i.e., the feeding of sheets of paper from the printing press is continued during this process. The following sheets of paper are stacked on the inserted insert 20.

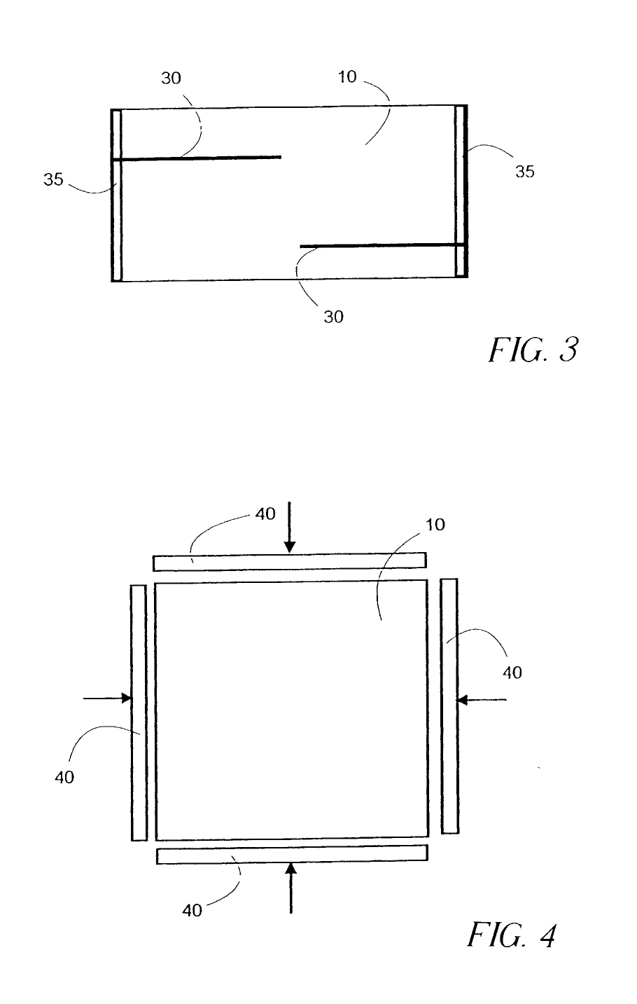

FIG. 3 shows another embodiment of the invention. This is a front view of an outline of a paper stack 10 that has been uniformly leveled by inserts, with a measuring device, whereby the inserts have some of the dimensions of the stacked sheets. In comparison with the embodiment in FIG. 1, there are two significant differences. The first difference concerns the inserts 30. The inserts 30 have a smaller face than the stacked sheets of paper on the paper stack 10; in FIG. 3, they are approximately half the length and face of the stacked sheets of paper. The second difference is that measuring devices 35 are provided, which measure and compare the stack height of the paper stack 10 on the right side and on the left side. The measuring may be carried out over the entire height of the sheet stack within the stacker at regular intervals. If, for example, the difference values of the measured stack height and those determined by the comparison exceed a given tolerance value, i.e., the paper stack 10 is unevenly stacked, an insert 30 is inserted into the paper stack 10. If, for example, the stack height measured by the measuring devices 35 is 55 cm on the left side and 54 cm on the right side, a simple difference formation of an error height of 1 cm is calculated in a computer associated with the measuring device 35, or in a control device of the printing press. If the tolerance value of the stack height is selected to be 1 cm, and the calculated error of 1 cm is exceeded in this example, a signal triggers the control device of the printing press to insert an insert 30. Of course, below the tolerance value of the measurements of the measuring devices 35 (below a stack height error of 1 cm), no insert 30 is inserted into the paper stack 10.

FIG. 4 shows a further development of the invention by a top view of the outline of a paper stack 10. As illustrated, the supporting components 40, such as sheet metal grids or bars, which somewhat cover up the side faces of the paper stack 10, are directed toward the four sides of the paper stack 10 and uniformly grip the latter with slight pressure. Now a vibration device is triggered, which shakes either the gripping supporting components 40 (or alternatively a baseplate on which the paper stack 10 is lying). The vibration device may contain a suitable motor that causes the supporting components 40 (or the baseplate) to move back and forth. By the combination of the vibration device and the gripping supporting components 40, the sheets of paper on the paper stack 10 are aligned in their longitudinal and transversal direction in such a way that the sheets of paper subsequently lie exactly on top of one another without shifting their positions, and with the paper stack 10 maintained level as described above, the paper stack may be readily automatically further processed.

The invention has been described in detail with particular reference to certain preferred embodiments thereof, but it will be understood that variations and modifications can be effected within the spirit and scope of the invention.

What is claimed is:

1. Method for stacking sheets of paper in the area of a printing press, characterized in that the level of stacks of sheets in the paper stack (10) is measured, and if the measurement indicates a level difference error exceeding a preselected difference error, the insertion of an insert (20, 30) is triggered whereby such inserts (20, 30) are used between the sheets of paper of the paper stack (10) to level the paper stack (10).

2. Stacker of a printing press characterized by inserts (20, 30) adapted to be imported between the sheets of paper of a paper stack (10) to level the paper stack (10), at least one measuring device (35) for measuring a uniform stack height of the sheets of paper of a paper stack (10), and a triggering device to trigger the insertion of an insert (20, 30) based on the measurements of the measuring device (35).

3. Stacker of a printing press according to claim 2, characterized in that the inserts (20, 30) are made of sheet metal and have approximately the same dimensions as the stacked sheets of paper.

4. Stacker of a printing press according to claim 2, characterized in that the inserts (20, 30) have dimension of a part of the face of the stacked sheets of paper.

5. Stacker of a printing press according to claim 2, characterized by gripping supporting components (40) on the sides of the paper stack (10), and at least one vibration device associated with said gripping supporting components (40) for exact alignment of the sheets of paper in a longitudinal and transverse direction of the paper stack (10).
